(19) United States
(12) Patent Application Publication
(10) Pub. No.: US 2024/0021085 A1
(43) Pub. Date: Jan. 18, 2024

(54) FLEXIBLE BERTH MANAGEMENT SYSTEM

(71) Applicant: SAP SE, Walldorf (DE)

(72) Inventor: Marcus DETTENBACH, Wiesloch (DE)

(21) Appl. No.: 17/865,682

(22) Filed: Jul. 15, 2022

(51) Int. Cl. G08G 3/00

(52) U.S. Cl. CPC G08G 3/00

(57) ABSTRACT

Systems and methods include determination of a plurality of object berth positions, determination of a first incoming time of a first object, determination of a stay duration of the first object, determination of an incoming stay duration of the first object and an outgoing stay duration of the first object, determination of a plurality of discrete incoming stay intervals of the first object based on the first incoming time and the incoming stay duration, determination of a plurality of discrete outgoing stay intervals of the first object based on the plurality of discrete incoming stay intervals of the first object, the incoming stay duration of the first object and the outgoing stay duration of the first object, and identification of one of the plurality of discrete incoming stay intervals of the first object, a first one of the plurality of object berth positions as an incoming berth position of the first object, one of the plurality of discrete outgoing stay intervals of the first object, and a second one of the plurality of object berth positions as an outgoing berth position of the first object based on values associated with the first object at each of the object berth positions during an incoming stay of the first object and on values associated with the first object at each of the object berth positions during an outgoing stay of the first object.

### BACKGROUND

Competition between harbors for inbound vessels has been increasing and is projected to continue to do so. Harbor operators attempt to attract carriers by providing faster turnaround times at lower costs than competitors. However, expanding and improving harbor infrastructure to meet these requirements is extremely costly and time-consuming.

Berth allocation refers to the assignment of a set of vessels to respective berth locations within a harbor at respective times. Berth allocation may be optimized for many different objectives, including minimization of time spent in the harbor and minimization of the overall cost of berthing. Accordingly, improvements to berth allocation may efficiently improve berthing speed and cost without requiring changes to harbor infrastructure.

A set of vessels to be berthed can be considered as the demand side of a berth allocation problem. Each vessel is associated with a stay (i.e., visit) duration, an incoming (i.e., arrival) time, vessel-specific attributes such as length and draft, and cargo-specific information such as a preferred storage area or special handling requirements. A harbor's infrastructure represents the supply side of the problem and includes berths with specific size capacities and equipment such as cranes, pumps etc. Additional constraints may include a maximum number of vessels per berth, a minimum distance between vessels and a minimum time between berthing vessels at a same berth position.

Improvements to existing approaches to the berth allocation problem are desired.

### BRIEF DESCRIPTION OF THE DRAWINGS

FIG. 1A is a diagram depicting vessels assigned to berth positions at a first time as specified by a first set of berth plans according to some embodiments.

FIG. 1B is a diagram depicting vessels assigned to berth positions at the first time as specified by a second set of berth plans according to some embodiments.

FIG. 1C is a diagram depicting vessels assigned to berth positions at a second time as specified by the second set of berth plans according to some embodiments.

FIG. 2A illustrates assignment of vessels to a berth based on arrival times.

FIG. 2B illustrates assignment of vessels to a berth based on flexible arrival times according to some embodiments.

FIG. 3A illustrates assignment of a vessel visit to a single berth position according to some embodiments.

FIG. 3B illustrates assignment of a vessel visit to an inbound berth position and an outbound berth position according to some embodiments.

FIG. 4 is a block diagram illustrating generation of berth plans according to some embodiments.

FIG. 5 is a flow diagram of pre-processing vessel visit information according to some embodiments.

FIG. 6 is a block diagram of a computing system to generate berth plans according to some embodiments.

FIG. 7 is an outward view of a user interface to receive vessel visit information according to some embodiments.

FIG. 8 is a block diagram of a cloud-based computing architecture according to some embodiments.

### DETAILED DESCRIPTION

The following description is provided to enable any person in the art to make and use the described embodiments. Various modifications, however, will remain readily-apparent to those in the art.

Some embodiments allow a user to define an arbitrary set of attributes for objects (i.e., vessels) and cargo to be matched with the attributes of various berth positions. Vessel attributes may include flexible incoming times. For example, a user may specify an earliest and latest arrival time for a given vessel together with a minimal stay duration, and the system determines an optimal arrival time therefrom. This feature adds a degree of freedom to the berthing problem and models actual anticipated scenarios more realistically than alternatives.

Embodiments may also determine a berth plan in which a vessel is unloaded at a first berth position and is loaded at a second berth position. The first and second berth positions may be located in different berths. The user may selectively indicate whether a vessel is permitted to be assigned such berthings. This aspect allows the berth plan to take into account real customer scenarios in which the handling effort for loading and unloading differs significantly between berth positions. This aspect also allows for planning of vessels which could not otherwise be planned due to different unloading and loading constraints which could not be met at a single berth position. Moreover, this aspect increases the flexibility of the overall set of berth plans and might allow for more vessels to be berthed than otherwise.

Embodiments may model the berth allocation problem as a set partitioning problem. For example, the planning horizon is divided into discrete time intervals and a set of feasible berth plans is generated. Each berth plan represents a feasible berth assignment of a single vessel, considering cargo and vessel-specific attributes (e.g., special handling requirements, vessel draft) and flexible arrival and departure dates. Berth plans which specify movement of a vessel between berth positions during its visit are also generated.

The costs for each berth plan may be determined as the sum of the cargo handling effort and costs for moving a vessel between berth positions (if applicable). The resulting optimization problem is to find a subset of berth plans that provides berthing for each vessel, minimizes total costs, and considers constraints such as, but not limited to, minimum time and spatial distance between vessels, maximum vessel capacity of a berth, and prioritization of berth positions and/or vessels. Such a problem can be solved efficiently using commercial solvers.

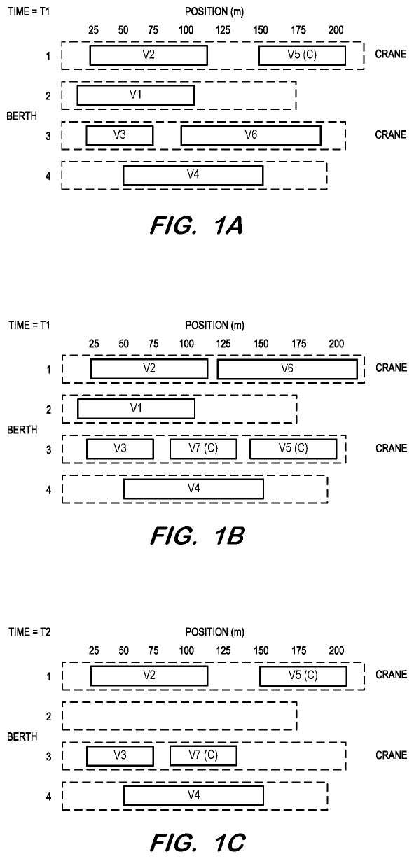

FIG. 1A is a diagram depicting assignment of vessels to berth positions at time T1 according to a first set of berth plans. Each of the first set of berth plans assigns a vessel to a berth position for a particular time period, or to a first berth position for a first time period and a second berth position for a second time period. As shown, more than one vessel may reside simultaneously within a given berth according to some embodiments.

The first set of berth plans may have been generated according to some embodiments based on characteristics of each of vessels V1-V6 (hereinafter referred to as “vessel visit information”) and of each of berths 1-4. For example, as denoted by “(C)”, loading or unloading of vessel V5 requires a crane. Vessel V5 has therefore been assigned to a berth which provides a crane, i.e., berth 1.

FIG. 1B is a diagram depicting assignment of vessels to berth positions at time T1 according to a second set of berth plans. For example, vessel visit information for vessel V7 may be received after generation of the first set of berth plans depicted in FIG. 1A. The vessel visit information may indicate that vessel V7 is to be berthed at time T1. To ensure berthing of all of vessels V1-V7, a new set of berth plans may therefore be generated based on the vessel visit information of vessels V1-V7 and of each of berths 1-4 as described herein. The new set of plans is generated to optimize cost while suitably berthing each vessel in accordance with the vessel visit information, berth characteristics and various constraints.

As shown in FIG. 1B, the new set of berth plans assigns vessel V7 to a position of berth 3. Berth 3 provides a crane, in accordance with the vessel visit information of vessel V7. Moreover, the berth plan for vessel V6 assigns vessel V6 to a position of berth 1, as opposed to the position of berth 3 specified by the FIG. 1A berth plan. The assignment of vessel V5 has been moved from a position of berth 1 to a position of berth 3, which also provides a crane as required by vessel V5.

FIG. 1C is a diagram depicting assignment of vessels to berth positions at time T2>T1 according to the second set of berth plans. At time T2, vessels V2, V3, V4 and V7 remain in the same berth positions at which they were located at time T1. Vessels V1 and V6 have departed the harbor because their berth plans specified departure times between times T1 and T2.

Vessel V5 has moved from a position of berth 3 to a position of berth 1. More specifically, the second berth plan for vessel V5 specifies unloading vessel V5 at the position of berth 3 for a time period which includes time T1 and loading vessel V5 at the position of berth 1 for a time period which includes time T2.

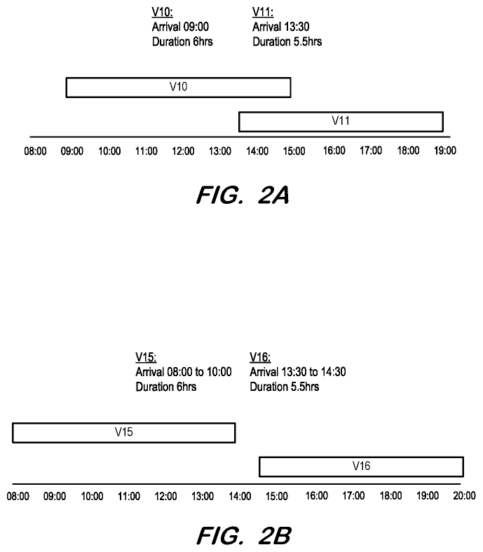

FIG. 2A illustrates assignment of vessels to berth positions based on specified vessel arrival times. As shown, the vessel visit information for vessel V10 specifies an arrival time of 09:00 and a visit duration of 6 hours. The vessel visit information for vessel V11 specifies an arrival time of 13:30 and a visit duration of 5.5 hours. Due to these values, vessels V10 and V11 will both be berthed during the time period between 13:30 and 15:00. Accordingly, vessels V10 and V11 cannot be assigned to any berth positions which would cause the vessels to physically overlap.

FIG. 2B illustrates assignment of vessels to berth positions in the case of flexible arrival times according to some embodiments. The vessel visit information for vessel V15 specifies an arrival time between 08:00 and 10:00 and a visit duration of 6 hours, while the vessel visit information for vessel V16 specifies an arrival time between 13:30 and 14:30 and a visit duration of 5.5 hours. It will also be assumed that a constraint exists specifying that two vessels may not occupy a same area of a berth within 30 minutes of one another. According to some embodiments, a berth plan for vessel V15 may be generated which specifies an arrival time of 08:00 and a berth plan for vessel V16 may be generated which specifies an arrival time of 13:30. Since the visits of the vessels do not overlap in time, each vessel may be assigned to a position by its berth plan without regard to the assigned position of the other vessel.

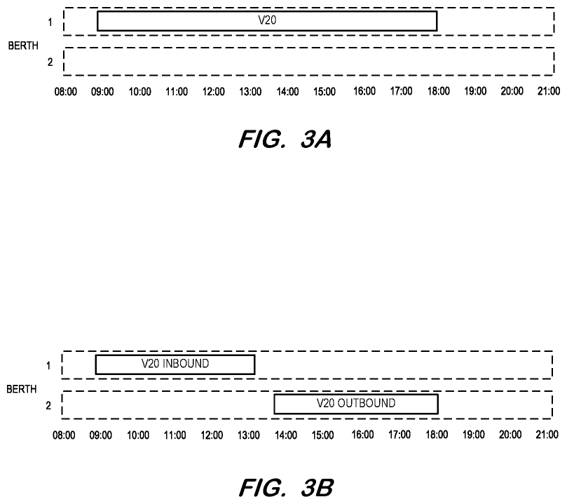

FIG. 3A illustrates assignment of a vessel visit to a single berth position for its whole visit according to some embodiments. It is assumed that Vessel V20 would incur 150 in unloading costs and 300 in unloading costs if positioned at berth 1, and would incur 350 in unloading costs and 150 in loading costs if positioned at berth 2. All else being equal, vessel V20 is therefore assigned to berth 1 due to the total lower cost (i.e., 450 vs. 500).

As mentioned above, some embodiments allow for a berth plan to assign a vessel to a first berth position during unloading and to another berth position during loading. It will be assumed that such relocation is associated with a cost penalty (e.g., 100) and other constraints (e.g., 30 min relocation time). According to this example, the total cost of a berth plan as shown in FIG. 3B is 150 for unloading at berth 1+150 for loading at berth 2+100 relocation penalty=400, which is less than the cost of the FIG. 3A berth plan.

The respective durations of the incoming (i.e., inbound) and outgoing (i.e., outbound) portions of the berth plan may simply be one-half of the user-specified duration of the whole visit, plus one-half the relocation time. In some embodiments, the respective durations are user-specified or determined based on knowledge of the cargo to be loaded/unloaded, on an average cost of loading/unloading the vessel across all possible berth positions, and/or on other factors.

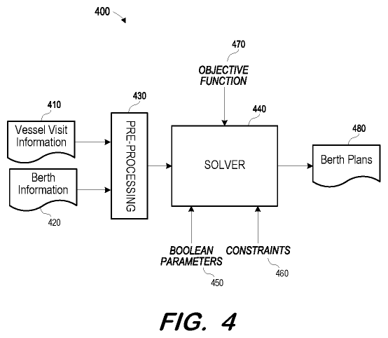

FIG. 4 is a block diagram of system 400 to generate berth plans according to some embodiments. As shown, berth plans 480 are generated based on vessel visit information 410 and berth information 420 as described above. Vessel visit information 410 and berth information 420 are received by pre-processing component 430, which generates definitions and parameters based thereon as will be described below. For example, pre-processing component 430 may discretize continuous values within vessel visit information 410 and berth information 420.

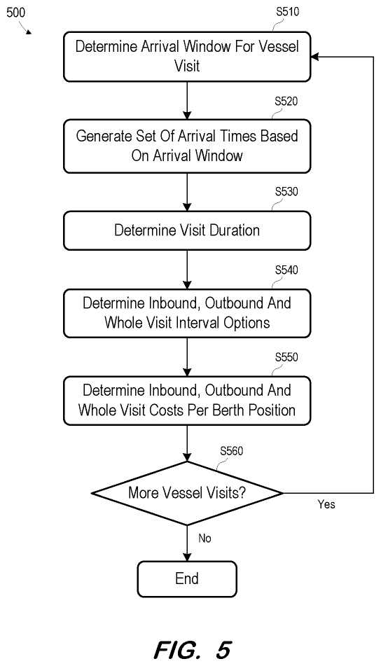

FIG. 5 is a flow diagram of process 500 which may be performed by pre-processing component 430 according to some embodiments. Process 500 may be performed using any suitable combination of hardware and software. Software program code embodying process 500 may be stored by any non-transitory tangible medium, including a fixed disk, a volatile or non-volatile random access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S510, the arrival window for a vessel visit is determined. In the present example, vessel visit information 410 includes information associated with a set of vessel visits I, where each vessel visit is associated with an identifier, e.g., ID1, ID2. The arrival window for a given vessel visit i may be specified in vessel visit information 410 as a range, such as 10:00 to 11:30.

A set of arrival times for the given vessel visit is generated at S520 based on the arrival window. The set of arrival times is a discretized representation of the arrival window. The more arrival times in the set, the more granular the timing of the berthing plans may be. However, more arrival times also increases the time and processing resources requires to solve the berth allocation problem. In the present example, the arrival window is discretized into thirty-minute blocks, resulting in the set of arrival times ETAᵢ for the given vessel visit i of 10.00, 10.30, 11.00, 11.30, 12:00 and 12:30.

Next, the duration of the visit is determined at S530. The duration of the visit may be explicitly specified within vessel visit information 110. In some embodiments, the duration is determined by pre-processing component 430 based on the cargo to be unloaded and the cargo to be loaded. Other techniques to determine the visit duration may be implemented.

S540 includes the determination of options for inbound visit intervals, outbound visit intervals and whole visit intervals. A whole visit interval specifies the start and end times of a visit in which the vessel is unloaded and loaded at a same berth position. An inbound visit interval specifies the start and end times of the unloading-only portion of a visit at a first berth position, while an outbound visit interval specifies the start and end times of the loading-only portion of the visit at a second berth position.

The visit intervals may be determined based on the set of arrival times generated at S520 and the visit duration determined at S530. For example, assuming a whole visit duration of four hours, the set of whole visit interval options H_{Whole} for i=ID1 may be determined as ID1_10:00_14:00, ID1_10:30_14:30, ID1_11:00_15:00, ID1_11:30_15:30, ID1_12:00_16:00, and ID1_12:30_16:30.

The inbound visit intervals and outbound visit intervals may be determined based on the whole visit duration and on a specified relocation time. As described above, the duration of each inbound visit intervals and outbound visit interval may be equal to one-half the whole visit duration plus one-half the relocation time. In some embodiments, pre-processing component 430 determines the inbound visit intervals and outbound visit intervals based on the cargo to be loaded and unloaded, and/or on other suitable factors.

Continuing the present example, the set of inbound visit interval options H_{inbound} for i=ID1 may be determined as ID1_Inbound_10:00_12:00, ID1_Inbound_10:30_12:30, ID1_Inbound_11:00_13:00, ID1_Inbound_11:30_12:30, ID1_Inbound_12:00_14:00, and ID1_Inbound_12:30_14:30. Similarly, the set of outbound visit interval options H_{Outbound} for i=ID1 may be determined as ID1_Outbound_12:00_14:00, ID1_Outbound_12:30_14:30, ID1_Outbound_13:00_15:00, ID1_Outbound_13:30_15:30, ID1_Outbound_14:00_16:00, ID1_Outbound_14:30_16:30.

Additional visit interval options may be determined for whole, inbound and/or outbound visits lasting longer than the minimum duration, at the cost of additional processing complexity. For purposes of the equations below, the entire set of interval options is denoted as H:=H_{inbound}∪H_{Outbound}∪H_{Whole}.

Inbound, outbound and whole visit values (i.e., costs) per berth position are determined at S550. Berth information 420 received by pre-processor may specify a set of berths B, e.g., AK1, AK2, KH_C, KH_D, a set of berth positions L per berth position B, e.g., AK1_60, AK1_70, and a set of berth positioning options J, e.g. AK1_60_U, AK1_60_D, AK1_70_U, AK1_70_D, where_D indicates a positioning in which the aft end of a vessel is at the specified berth position and the fore end is at a lower berth position. For example, AK1_60_D indicates that the aft end is at a 60 meter berth position and the fore end is at a 5 meter berth position in the case of a 55 meter vessel. Similarly, AK1_60_U indicates that the aft end is at a 60 meter berth position and the fore end is at a 115 meter berth position in the case of a 55 meter vessel.

Berth information 420 may be provided by a harbor employee. The berth positions may be specified at any granularity (e.g., every 2 meters, every 10 meters, every 25 meters), with finer granularity providing more planning flexibility but requiring more processing time and resources. Berth information 420 may further specify a maximum number of ships per berth O_{b} and time intervals b_{kI} for which a section of or an entire berth cannot be used for berthing (e.g., due to maintenance work at the berth).

Pre-processing component 430 may determine costs per berth position at S550 based on the cargo to be loaded and unloaded at each berth position, the equipment available at each berth position, the distance from each berth position to storage for the cargo to be unloaded or loaded, etc. Such information may be provided by vessel visit information 410 and berth information 420. For purposes of the equations below, the determined costs may be represented as follows:

cₕⱼ^{I}=“Cost of inbound visit interval option h at berth option j”,∀h∈H_{Inbound},j∈J

cₕⱼ⁰=“Cost of outbound visit interval option h at berth option j”,∀h∈H_{Outbound},j∈J

cₕⱼ^{W}=“Cost of whole visit interval h at berth option j”,∀h∈H_{Whole},j∈J

In some embodiments, cₕⱼⁱ and cₕⱼ⁰ each include half of a vessel relocation penalty.

Also defined for is \tilde{c}ᵢ, which represents the cost of not planning visit i. \tilde{c}ᵢ supports embodiments in which an optimal set of berth plans might not include berthing a particular vessel, even considering the (presumably high) cost of not planning the visit. As will be described below, some embodiments define a virtual berth to which a visit may be planned, where the cost of the visit is \tilde{c}ᵢ. \tilde{c}ᵢ may be defined within vessel visit information 410 by a vessel operator, or may be assigned by a harbor operator based on vessel priorities (e.g., a higher priority vessel is associated with a higher value of \tilde{c}ᵢ).

At S560, it is determined whether additional vessel visits should be considered in the generation of the set of berth plans. If so, flow returns to S510 and proceeds as described above with respect to a next vessel visit. If not, process 500 terminates.

Returning to FIG. 4, pre-processing component 430 provides the information described above to solver 440. Also provided to solver are Boolean parameters 450 and constraints 460. According to some embodiments, Boolean parameters 450 include dᵢₕ, pₑₕ, tₕₖ, and m_{ijI}, defined as follows:

$${d}_{ih} = \{ \begin{matrix}1 , if inbound / outbound / whole visit option h belongs to visit i \\ 0 , else\end{matrix} , ∀ i ∈ I , h ∈ H$$

$${P}_{eh} = \{ \begin{matrix}1 , if inbound / outbound visit option h belongs to ETA value e \\ 0 , else\end{matrix} ,$$

$$∀ e ∈ {ETA}_{i} , h ∈ {H}_{Inbound} ⋃ {H}_{Outbound} : {d}_{ih} = 1$$

$${t}_{hk} = \{ 1 , if inbound / outbound / whole ship visit option h contains time interval k$$

$${t}_{hk} = \\ \{ \text{} \begin{matrix}1 , if inbound / outbound / whole ship visit option h contains time interval k \\ 0 , else\end{matrix} , ∀ h ∈ H , k ∈ {U}_{b ∈ B} {K}_{b}$$

$${m}_{ijl} = \{ \begin{matrix}1 , if ship visit i blocks berth position l when assigned to berth option j \\ 0 , else\end{matrix}$$

$${b}_{kl} = \{ \begin{matrix}1 , if berth position l is blocked in time interval k \\ 0 , else\end{matrix} ∀ h ∈ H , k ∈ {⋃}_{b ∈ B} {K}_{b}$$

Solver 440 determines values of decision variables xₕⱼⁱ, xₕⱼ⁰, xₕⱼ^{W}, zᵢ which minimize objective function 470 based on the information from pre-processing component 430 and in view of Boolean parameters 450 constraints 460. Objective function 470 according to some embodiments is as follows:

$${min}_{{x}_{j} , {z}_{i} ∈ \{ 0 , 1 \}} {\sum }_{h ∈ {H}_{Inbound}} {\sum }_{j ∈ J} {c}_{hj}^{I} {x}_{hj}^{I} + {\sum }_{h ∈ {H}_{Outbound}} {\sum }_{j ∈ J} {c}_{hj}^{O} {x}_{hj}^{O} + {\sum }_{h ∈ {H}_{Whole}} {\sum }_{j ∈ J} {c}_{hj}^{W} {x}_{hj}^{W} + {\sum }_{i ∈ J} {\overline{c}}_{i} {z}_{i}$$

$$where$$

$${x}_{hj}^{I} = \{ \begin{matrix}1 , if inbound ship visit option h is assigned to berth option j \\ 0 , else\end{matrix} ∀ h ∈ {H}_{inbound , j ∈ J}$$

$${x}_{hj}^{O} = \{ \begin{matrix}1 , if outbound ship visit option h is assigned to berth option j \\ 0 , else\end{matrix} ∀ h ∈ {H}_{Outbound , j ∈ J}$$

$${x}_{hj}^{W} = \{ \begin{matrix}1 , if whole ship visit option h is assigned to berth option j \\ 0 , else\end{matrix} ∀ h ∈ {H}_{Whole , j ∈ J}$$

$${z}_{i} = \{ \begin{matrix}1 , if ship visit i is not planned ( planned to virtual berth ) \\ 0 , else\end{matrix} ∀ i ∈ I$$

Constraints 460 may fall into several different categories. For example, constraints 460 may consist of assignment constraints to ensure that each vessel is associated with a single berth plan and that each inbound berthing is associated with a corresponding outbound berthing. Such assignment constraints may be represented mathematically as follows:

$${\sum }_{h ∈ {H}_{Inbound}} {\sum }_{j ∈ J} {d}_{ih} {x}_{hj}^{I} + {\sum }_{h ∈ {H}_{Whole}} {\sum }_{j ∈ J} {d}_{ih} {x}_{hj}^{W} + {z}_{i} \geq 1 ∀ i ∈ I$$

$${\sum }_{h ∈ {H}_{Outbound}} {\sum }_{j ∈ J} {d}_{ih} {P}_{eh} {x}_{hj}^{I} + {\sum }_{h ∈ {H}_{Whole}} {\sum }_{j ∈ J} {d}_{ih} {x}_{hj}^{W} + {z}_{i} \geq 1 ∀ i ∈ I$$

Constraints 460 may also include temporal constraints to ensure that a vessel moves to an outbound berth only after the inbound berth is complete:

$${\sum }_{h ∈ {H}_{Inbound}} {\sum }_{j ∈ J} {d}_{ih} {P}_{eh} {x}_{hj}^{I} + {\sum }_{h ∈ {H}_{Outbound}} {\sum }_{j ∈ J} {d}_{ih} ( 1 - {p}_{eh} ) {x}_{hj}^{O} \leq 1 ∀ i ∈ I , ∀ e ∈ {ETA}_{i}$$

It is noted that the option to schedule separate inbound and outbound berthings for a vessel may be disabled by setting H_{Inbound}=H_{Outbound}=0, since xₕⱼ^{I} and xₕⱼ⁰ will not exist in that case and the above constraint degenerates to 0<=1. Similarly, the option to consider flexible arrival times may be unused if only a single ETA is provided for each vessel visit.

Other constraints 460 prevent two vessels from occupying the same space at the same time:

$${\sum }_{i ∈} {\sum }_{h ∈ H} {\sum }_{j ∈ J} {t}_{hk} {d}_{ih} {m}_{iji} {x}_{hj}^{I , O , W} \leq 1 - {b}_{kl} ∀ l ∈ L , k ∈ {K}_{Berth ( l )}$$

Moreover, constraints 460 may include a constraint based on the maximum number of ships per berth (i.e., K_{b}), where xₕⱼ^{I,O,W} means xₕⱼ^{I} or xₕⱼ^{O} or xₕⱼ^{W}:

$${\sum }_{h ∈ H} {\sum }_{j ∈ J : Berth ( j ) = b} {t}_{hk} {x}_{hj}^{I , O , W} \leq {0}_{b} ∀ b ∈ B , k ∈ {K}_{b}$$

Solver 440 may comprise any suitable techniques to optimize objective function 470 based on the above-described inputs. Examples include but are not limited to SCIP and CPLEX solvers. The output of solver 440 includes values of xₕⱼ^{I} or xₕⱼ^{O} or xₕⱼ^{W}, zᵢ which specify berth plans 480. Berth plans 480 specify, for each vessel visit of vessel visit information 410, a visit interval for a whole visit at a particular berth position (which may be a berth position of a virtual berth), or an inbound visit interval at a first berth position and an outbound visit interval at a second berth position. Berth plans 480 may be presented to a user (e.g., a vessel operator or harbor operator) using any suitable graphical or other representation.

Pre-processing component 430 and solver 440 may be implemented using any combination of hardware and/or software that is or becomes known. Such combinations may include one or more programmable processors (microprocessors, central processing units, microprocessor cores, execution threads), one or more non-transitory electronic storage media, and processor-executable program code. In some embodiments, two or more components of system 400 are implemented by a single computing device, and/or two or more components of system 400 are co-located. One or more components of system 400 may be implemented using cloud-based resources, and/or other systems which apportion computing resources elastically according to demand, need, price, and/or any other metric.

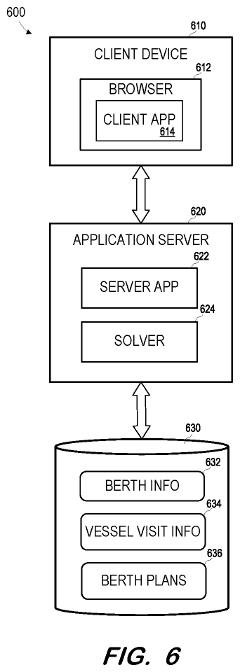

FIG. 6 illustrates one example of a computing system which may implement some embodiments. Client device 610 may comprise any computing system, such as a desktop computer, a laptop computer or a smartphone, operated by any user. Client device 610 may execute a Web browser 612 including a virtual machine which in turn executes client application 614. Client application 614 may be a standalone application which executes on an operating system of client device 610.

Client device 610 executes client application 614 to communicate with server application 622 of application server 620. Application server 620 comprises a computing server, distributed group of servers, or cluster of servers which provide services for executing server applications. Web applications executing on application server 620 may receive Hypertext Transfer Protocol (HTTP) requests from corresponding client applications such as client application 614 and provide responses thereto.

In the present example, server application 622 may receive vessel visit information and berth information and pre-process the information as described above. Server application 622 may provide the pre-processed information to solver 624 along with Boolean parameters and constraints to generate berth plans. The generated berth plans may be presented to users via client application 614.

Received vessel visit information, received berth information and generated berth plans may be stored in storage system 630. Storage system 630 may comprise any suitable storage system, including distributed and cloud-based storage systems. The data of storage system 630 may comprise one or more of conventional tabular data, row-stored data, column-stored data, and object-based data. Moreover, the data may be indexed and/or selectively replicated in an index to allow fast searching and retrieval thereof.

Storage system 630 may comprise an “in-memory” database, in which a full database is stored in volatile (e.g., non-disk-based) memory (e.g., Random Access Memory). The full database may be persisted in and/or backed up to fixed disks. Embodiments are not limited to an in-memory implementation. For example, data may be stored in Random Access Memory (e.g., cache memory for storing recently-used data) and one or more fixed disks (e.g., persistent memory for storing their respective portions of the full database).

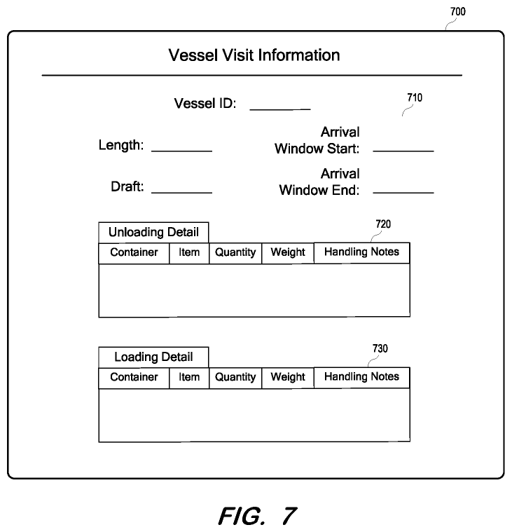

FIG. 7 is a view of interface 700 for receiving vessel visit information according to some embodiments. Interface 700 may be presented to a user via a Web browser executing a client application as described above. Interface 700 may also comprise a user interface of a standalone local application. Embodiments are not limited to the format or content of interface 700.

Section 710 of interface 700 allows submission, for a particular vessel visit, of a vessel ID, length, and draft. Section 710 also allows specification of an arrival window start time and an arrival window end time, which are usable as described above. Section 720 of interface 700 allows submission of details relating to the cargo which is to be unloaded from the vessel during the visit. Similarly, section 730 of interface 700 allows submission of details relating to the cargo which is to be loaded onto the vessel during the visit. As mentioned above, such information may be used to determine a whole visit duration, an inbound visit duration, an out bound visit duration, and berth equipment constraints.

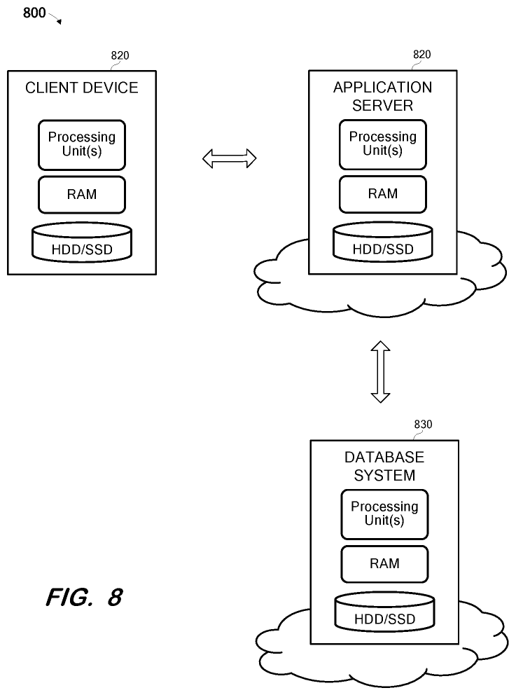

FIG. 8 is a block diagram of cloud-based system 800 according to some embodiments. In this regard, application server 820 and database system 830 may comprise cloud-based compute resources, such as virtual machines, allocated by a public cloud provider providing self-service and immediate provisioning, autoscaling, security, compliance and identity management features.

Client device 810 may interact with user interfaces of a service or application executing on application server 820, for example via a Web browser executing on client device 810. These user interfaces may provide the ability to submit vessel visit information and/or berth information, and to initiate generation of a corresponding set of berth plans. The generation of the berth plans may be performed by an application or service executing on application server 820, in conjunction with data stored within database system 830. Database system 830 may also store the generated berth plans.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of architectures described herein may include a programmable processor to execute program code such that the computing device operates as described herein.

All systems and processes discussed herein may be embodied in program code stored on one or more non-transitory computer-readable media. Such media may include, for example, a DVD-ROM, a Flash drive, magnetic tape, and solid-state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

What is claimed is:

1. A system comprising:
a memory storing processor-executable program code; and
a processing unit to execute the processor-executable program code to cause the system to:
determine a plurality of object berth positions;
determine a first incoming time of a first object;
determine a stay duration of the first object;
determine an incoming stay duration of the first object and an outgoing stay duration of the first object;
determine a plurality of discrete incoming stay intervals of the first object based on the first incoming time and the incoming stay duration;
determine a plurality of discrete outgoing stay intervals of the first object based on the plurality of discrete incoming stay intervals of the first object, the incoming stay duration of the first object and the outgoing stay duration of the first object; and
identify one of the plurality of discrete incoming stay intervals of the first object, a first one of the plurality of object berth positions as an incoming berth position of the first object, one of the plurality of discrete outgoing stay intervals of the first object, and a second one of the plurality of object berth positions as an outgoing berth position of the first object based on values associated with the first object at each of the object berth positions during an incoming stay of the first object and on values associated with the first object at each of the object berth positions during an outgoing stay of the first object.

2. A system according to claim 1, wherein determination of a plurality of discrete outgoing stay intervals of the first object is based on the plurality of discrete incoming stay intervals of the first object, the incoming stay duration of the first object, the outgoing stay duration of the first object, and a object relocation time of the first object.

3. A system according to claim 1, the processing unit to execute the processor-executable program code to cause the system to:
determine a second incoming time of a second object;
determine a second stay duration of the second object;
determine a second incoming stay duration of the second object and a second outgoing stay duration of the second object;
determine a second plurality of discrete incoming stay intervals of the second object based on the second incoming time and the second incoming stay duration;
determine a second plurality of discrete outgoing stay intervals of the second object based on the second plurality of discrete incoming stay intervals of the second object, the second incoming stay duration of the second object and the second outgoing stay duration of the second object; and
identify one of the plurality of discrete incoming stay intervals of the second object, a third one of the plurality of object berth positions as an incoming berth position of the second object, one of the plurality of discrete outgoing stay intervals of the second object, and a fourth one of the plurality of object berth positions as an outgoing berth position of the second object based on the values associated with the first object at each of the object berth positions during an incoming stay of the first object, the values associated with the first object at each of the object berth positions during an outgoing stay of the first object, the values associated with the second object at each of the object berth positions during an incoming stay of the second object, and the values associated with the second object at each of the object berth positions during an outgoing stay of the second object.

4. A system according to claim 3,
wherein determination of the first incoming time comprises determination of a first start incoming time and a first end incoming time,
wherein determination of the second incoming time comprises determination of a second start incoming time and a second end incoming time,
wherein determination of the plurality of discrete incoming stay intervals of the first object is based on the first start incoming time, the first end incoming time and the first incoming stay duration, and
wherein determination of the second plurality of discrete incoming stay intervals of the second object is based on the second start incoming time, the second end incoming time and the second incoming stay duration.

5. A system according to claim 1,
wherein determination of the first incoming time comprises determination of a first start incoming time and a first end incoming time, and
wherein determination of the plurality of discrete incoming stay intervals of the first object is based on the first start incoming time, the first end incoming time and the first incoming stay duration.

6. A system according to claim 5, wherein determination of a plurality of discrete outgoing stay intervals of the first object is based on the plurality of discrete incoming stay intervals of the first object, the incoming stay duration of the first object, the outgoing stay duration of the first object, and a object relocation time of the first object.

7. A computer-implemented method, comprising:
determining a plurality of object berth positions;
determining a first incoming time of a first object;
determining a stay duration of the first object;
determining an incoming stay duration of the first object and an outgoing stay duration of the first object;
determining a plurality of discrete incoming stay intervals of the first object based on the first incoming time and the incoming stay duration;
determining a plurality of discrete outgoing stay intervals of the first object based on the plurality of discrete incoming stay intervals of the first object, the incoming stay duration of the first object and the outgoing stay duration of the first object; and
identifying one of the plurality of discrete incoming stay intervals of the first object, a first one of the plurality of object berth positions as an incoming berth position of the first object, one of the plurality of discrete outgoing stay intervals of the first object, and a second one of the plurality of object berth positions as an outgoing berth position of the first object based on values associated with the first object at each of the object berth positions during an incoming stay of the first object and on values associated with the first object at each of the object berth positions during an outgoing stay of the first object.

8. A method according to claim 7, wherein determining a plurality of discrete outgoing stay intervals of the first object is based on the plurality of discrete incoming stay intervals of the first object, the incoming stay duration of the first object, the outgoing stay duration of the first object, and a object relocation time of the first object.

9. A method according to claim 7, further comprising:
determining a second incoming time of a second object;
determining a second stay duration of the second object;
determining a second incoming stay duration of the second object and a second outgoing stay duration of the second object;
determining a second plurality of discrete incoming stay intervals of the second object based on the second incoming time and the second incoming stay duration;
determining a second plurality of discrete outgoing stay intervals of the second object based on the second plurality of discrete incoming stay intervals of the second object, the second incoming stay duration of the second object and the second outgoing stay duration of the second object; and
identifying one of the plurality of discrete incoming stay intervals of the second object, a third one of the plurality of object berth positions as an incoming berth position of the second object, one of the plurality of discrete outgoing stay intervals of the second object, and a fourth one of the plurality of object berth positions as an outgoing berth position of the second object based on the values associated with the first object at each of the object berth positions during an incoming stay of the first object, the values associated with the first object at each of the object berth positions during an outgoing stay of the first object, the values associated with the second object at each of the object berth positions during an incoming stay of the second object, and the values associated with the second object at each of the object berth positions during an outgoing stay of the second object.

10. A method according to claim 9,
wherein determining the first incoming time comprises determination of a first start incoming time and a first end incoming time,
wherein determining the second incoming time comprises determination of a second start incoming time and a second end incoming time,
wherein determining the plurality of discrete incoming stay intervals of the first object is based on the first start incoming time, the first end incoming time and the first incoming stay duration, and
wherein determining the second plurality of discrete incoming stay intervals of the second object is based on the second start incoming time, the second end incoming time and the second incoming stay duration.

11. A method according to claim 7,
wherein determining the first incoming time comprises determination of a first start incoming time and a first end incoming time, and
wherein determining the plurality of discrete incoming stay intervals of the first object is based on the first start incoming time, the first end incoming time and the first incoming stay duration.

12. A method according to claim 11, wherein determining a plurality of discrete outgoing stay intervals of the first object is based on the plurality of discrete incoming stay intervals of the first object, the incoming stay duration of the first object, the outgoing stay duration of the first object, and a object relocation time of the first object.

13. A non-transitory computer-readable medium storing program code executable by a processing unit of a computing system to cause the computing system to:
determine a plurality of object berth positions;
determine a first incoming time of a first object;
determine a stay duration of the first object;
determine an incoming stay duration of the first object and an outgoing stay duration of the first object;
determine a plurality of discrete incoming stay intervals of the first object based on the first incoming time and the incoming stay duration;
determine a plurality of discrete outgoing stay intervals of the first object based on the plurality of discrete incoming stay intervals of the first object, the incoming stay duration of the first object and the outgoing stay duration of the first object; and
identify one of the plurality of discrete incoming stay intervals of the first object, a first one of the plurality of object berth positions as an incoming berth position of the first object, one of the plurality of discrete outgoing stay intervals of the first object, and a second one of the plurality of object berth positions as an outgoing berth position of the first object based on values associated with the first object at each of the object berth positions during an incoming stay of the first object and on values associated with the first object at each of the object berth positions during an outgoing stay of the first object.

14. A medium according to claim 13, wherein determination of a plurality of discrete outgoing stay intervals of the first object is based on the plurality of discrete incoming stay intervals of the first object, the incoming stay duration of the first object, the outgoing stay duration of the first object, and a object relocation time of the first object.

15. A medium according to claim 13, program code executable by a processing unit of a computing system to cause the computing system to:
determine a second incoming time of a second object;
determine a second stay duration of the second object;
determine a second incoming stay duration of the second object and a second outgoing stay duration of the second object;
determine a second plurality of discrete incoming stay intervals of the second object based on the second incoming time and the second incoming stay duration;
determine a second plurality of discrete outgoing stay intervals of the second object based on the second plurality of discrete incoming stay intervals of the second object, the second incoming stay duration of the second object and the second outgoing stay duration of the second object; and
identify one of the plurality of discrete incoming stay intervals of the second object, a third one of the plurality of object berth positions as an incoming berth position of the second object, one of the plurality of discrete outgoing stay intervals of the second object, and a fourth one of the plurality of object berth positions as an outgoing berth position of the second object based on the values associated with the first object at each of the object berth positions during an incoming stay of the first object, the values associated with the first object at each of the object berth positions during an outgoing stay of the first object, the values associated with the second object at each of the object berth positions during an incoming stay of the second object, and the values associated with the second object at each of the object berth positions during an outgoing stay of the second object.

16. A medium according to claim 15,
wherein determination of the first incoming time comprises determination of a first start incoming time and a first end incoming time,
wherein determination of the second incoming time comprises determination of a second start incoming time and a second end incoming time,
wherein determination of the plurality of discrete incoming stay intervals of the first object is based on the first start incoming time, the first end incoming time and the first incoming stay duration, and
wherein determination of the second plurality of discrete incoming stay intervals of the second object is based on the second start incoming time, the second end incoming time and the second incoming stay duration.

17. A medium according to claim 13,
wherein determination of the first incoming time comprises determination of a first start incoming time and a first end incoming time, and
wherein determination of the plurality of discrete incoming stay intervals of the first object is based on the first start incoming time, the first end incoming time and the first incoming stay duration.

18. A medium according to claim 17, wherein determination of a plurality of discrete outgoing stay intervals of the first object is based on the plurality of discrete incoming stay intervals of the first object, the incoming stay duration of the first object, the outgoing stay duration of the first object, and a object relocation time of the first object.
